(19) United States
(12) Patent Application Publication
(10) Pub. No.: US 2026/0241448 A1
(43) Pub. Date: Aug. 20, 2026

(54) PREPARATION PROCESS FOR METAL PART WITH COMPLEX INTERNAL CAVITY AND METAL NOZZLE

(71) Applicant: Huizhou Shindy Intelligent Manufacturing Technology Co., Ltd, Huizhou (CN)

(72) Inventors: Guoyao HE, Shenzhen (CN); Xiaoyong QU, Shenzhen (CN); Lei HU, Huizhou (CN); Yuanchi WU, Dongguan (CN); Xueyi DENG, Guilin (CN)

(21) Appl. No.: 19/642,407

(22) Filed: Apr. 8, 2026

(30) Foreign Application Priority Data
Jun. 12, 2025 (CN) 202510781244.6

(51) Int. Cl. B22F 5/10; B22F 1/10; B22F 3/10; B22F 3/22

(52) U.S. Cl. CPC B22F 5/10; B22F 1/10; B22F 3/1021; B22F 3/225; B22F 2005/103

(57) ABSTRACT

The present disclosure discloses a preparation process for a metal part with a complex internal cavity and a metal nozzle. The process includes the steps of polymer insert preparation, mold assembly, feedstock preparation, injection molding, catalytic debinding and sintering molding. A decomposable polymer insert A strictly matched with an internal cavity of a target metal part in geometric shape is pre-manufactured by injection molding to serve as a placeholder structure, then the polymer insert A is precisely fixed in a predetermined cavity of a forming mold during mold assembly to form a composite cavity structure with a predetermined clearance; metal nozzle feedstock is injected into the predetermined clearance of this composite cavity structure during injection molding; and the polymer insert A and binder are removed utilizing a gaseous acidic catalyst, thereby obtaining a high-precision metal part with a complex internal cavity.

### CROSS-REFERENCE TO RELATED APPLICATIONS

This application claims priority to Chinese Patent Application No. 202510781244.6, filed on Jun. 12, 2025, which is hereby incorporated by reference in its entirety.

### TECHNICAL FIELD

The present disclosure relates to the technical field of metal injection molding, and particularly relates to a preparation process for a metal part with a complex internal cavity and a metal nozzle.

### BACKGROUND

In the field of high-end medical device manufacturing, metal nozzles, as key functional components, exhibit multi-curvature compound-bent characteristics in their internal cavities. The nozzles include deep-cavity flow guide channels, thin-walled support structures, and precision-fitting interfaces, imposing stringent requirements on surface roughness and dimensional accuracy. Current mainstream manufacturing processes each have their shortcomings when dealing with such products.

The 3D printing metal technology, although having certain advantages in rapid prototyping and complex shape construction, has the disadvantages of poor internal surface quality and high roughness in its printed finished product, making it difficult to meet the smooth transitions and micron-level precision required for medical-grade precision connectors, thus limiting its application in this field.

The CNC metal machining technology, although being renowned for its high precision, has the disadvantages that when dealing with products with complex internal structures like metal nozzles, it is difficult for cutting tools to reach numerous slight bends, it is difficult to guarantee the machining accuracy, and it is difficult to precisely sculpt precise internal contours meeting design requirements, thereby being unable to fulfill its preparation task.

The MIM injection molding technology, although being known for its capability to efficiently mold plastic parts having complex shapes, precise sizes and being capable of embedding in metal or non-metal inserts, and having the advantages of high quality stability of products and broad application prospects in medical product manufacturing, has the disadvantages that it is difficult to design reasonable demolding angles and demolding paths due to complex internal structures of metal nozzles, and it is difficult to achieve conventional mechanical demolding, resulting in molding difficulties.

For a long time, the manufacturing technology for such high-precision and complex metal connectors has been monopolized by Japanese companies. This not only makes domestic related industries technologically dependent on others, causing technological dependence, but also leads to significant profit outflows, thereby severely restricting the independent and controllable development of domestic medical device industry chain.

### SUMMARY

To solve the above problems, one objective of the present disclosure is to provide a preparation process for a metal part with a complex internal cavity, including the following steps:
polymer insert preparation: preparing a polymer insert A strictly matched with an internal cavity of a target metal part in geometric shape from a thermoplastic polymer by using an injection molding process;
mold assembly: precisely fixing the polymer insert A in a predetermined cavity of a metal part forming mold to form a composite cavity structure with a predetermined clearance;
feedstock preparation: mixing metal powder and binder according to a mass ratio of 55-65:45-35 for granulation to prepare feedstock of the metal part, the binder and the thermoplastic polymer being the same compound, where using the same compound as both the polymer insert A and the binder serves dual purposes of: enhancing the compatibility between the metal feedstock and the polymer insert, enabling the two to be better combined to form a seamless bonding layer during injection molding, thereby preventing defects such as delamination caused by material incompatibility and improving the quality and molding stability of a green part; and ensuring the synchronous decomposition and removal of the polymer insert A and the binder during catalytic debinding, avoiding structural collapse or residual stress resulting from difference in decomposition rates in multi-component systems;
injection molding: heating the feedstock of the metal part to a molten state, injecting the feedstock into the predetermined clearance of the composite cavity structure by an MIM device, and performing cooling for dimensional stability to obtain a green part encapsulating the polymer insert A, denoted as a semi-finished product B;
catalytic debinding: placing the semi-finished product B in a catalytic debinding apparatus, introducing a first inert gas protective atmosphere into a closed environment at a temperature of 100-140° C. and a pressure of 100-200 MPa, and removing the polymer insert A utilizing a gaseous acidic catalyst, where under high temperature and high pressure conditions, acidic catalyst vapor (such as nitric acid or oxalic acid) can rapidly penetrate into the interior of the polymer insert A, induce acid-catalyzed chain-breaking depolymerization reactions, shorten the debinding cycle, and completely remove organic components through catalytic debinding prior to high-temperature sintering, thereby preventing the formation of bubbles and cracks during sintering that would affect the quality of the finished product; and
sintering molding: transferring the debound semi-finished product B to a sintering apparatus, heating to 1300-1400° C. at a rate of 10-20° C./min under a second inert gas protective atmosphere, and holding for 2.5-3.5 h to cause metal particles to undergo densification sintering to obtain a finished metal part with a complex internal cavity, where strict control of the heating rate and holding time during sintering not only prevents defects in metal parts, such as internal stress concentration, cracking, or deformation caused by rapid temperature changes during sintering, but also controls the grain growth rate to prevent excessive grain growth, so as to obtain a dense and uniformly structured finished metal part with a complex internal cavity, and improve the mechanical strength and fatigue resistance of the finished metal part.

Preferably, the thermoplastic polymer and the binder are both polyoxymethylene resin. The polyoxymethylene resin breaks carbon-oxygen bonds under the action of an acidic catalyst, decomposing into gaseous formaldehyde small molecular gas and being carried out of the green part along with the carrier gas, i.e., the first inert gas, thereby achieving simultaneous removal of the polymer insert A and the binder.

Preferably, the thermoplastic polymer and the binder are both polyketone resin. The polyketone resin decomposes into volatile oligomers and CO/CO₂ gases through molecular chain breaking under the action of an acidic catalyst.

Preferably, the catalyst is nitric acid or oxalic acid.

Preferably, a vapor concentration of the catalyst is controlled within the range of 10 vol % to 15 vol %, which can ensure the debinding effect while avoiding adverse effects such as corrosion of metal components caused by excessively high catalyst concentration.

Preferably, the metal powder used for preparing the feedstock of the metal part is stainless steel powder. Stainless steel has corrosion resistance, fatigue resistance, good biocompatibility and workability, and is suitable for manufacturing high-end medical devices and accessories.

Preferably, the stainless steel powder has a particle size of 0.1-1.5 μm. The use of stainless steel powder with this particle size distribution can ensure injection flowability and sintering densification, enabling the relative density of the sintered finished metal part to reach above 99.2%.

Preferably, the first inert gas protective atmosphere is nitrogen, and the second inert gas protective atmosphere is argon.

Preferably, during injection molding, an injection rate is controlled within the range of 50 cm³/s to 100 cm³/s, and cooling is performed at a rate of 20-40° C./min for dimensional stabilization. Controlling the injection rate within the range of 50 cm³/s to 100 cm³/s ensures that the metal feedstock rapidly fill the complex cavity to avoid component stratification and facilitate controlling the linear shrinkage rate of the semi-finished product B within the range of 1.5% to 2.5%; gradient cooling is conducive to suppressing shrinkage stress and grain coarsening, and is conducive to stabilizing the linear shrinkage rate and ensuring a surface roughness Ra≤1.6 μm of the finished metal part, meeting the high standard requirements of medical devices for cleanliness and biocompatibility.

Another objective of the present disclosure is to provide a metal nozzle, manufactured by using the above preparation process for a metal part with a complex internal cavity, including a body, a multi-curvature compound-bent internal cavity, and a connector.

The beneficial effects lie in:

The present disclosure provides a preparation process for a metal part with a complex internal cavity. A decomposable polymer insert A strictly matched with an internal cavity of a target metal part in geometric shape is pre-manufactured by injection molding to serve as a placeholder structure, then the polymer insert A is precisely fixed in a predetermined cavity of a forming mold during mold assembly to form a composite cavity structure with a predetermined clearance; metal nozzle feedstock is injected into the predetermined clearance of this composite cavity structure during injection molding; and the polymer insert A and binder are removed utilizing a gaseous acidic catalyst, thereby obtaining a high-precision metal part with a complex internal cavity, solving the technical problems of inability to machine complex internal cavities of the conventional CNC, high roughness of 3D-printed internal surfaces, and demolding difficulties in the MIM injection molding process. This process combines MIM metal injection molding with insert molding technology, circumvents the reliance on high-end CNC devices or imported 3D printing devices traditionally required for metal parts with complex internal cavities, reduces the demand threshold for specialized cutting tools and forming devices, and provides a feasible pathway for domestic enterprises to achieve independent and controllable production of precise metal nozzles, contributing to breaking the long-term monopoly of Japanese enterprises in this field and enhancing the security of the medical device industry chain . . .

### BRIEF DESCRIPTION OF THE DRAWINGS

The drawings described herein are provided to offer further understanding of the present disclosure and constitute a part thereof. The exemplary embodiments of the present disclosure and descriptions thereof are intended to explain the present disclosure and do not impose improper limitations on the present disclosure. In the drawings:

FIG. 1 is a schematic diagram of a cross-sectional structure of a metal nozzle in the present disclosure;

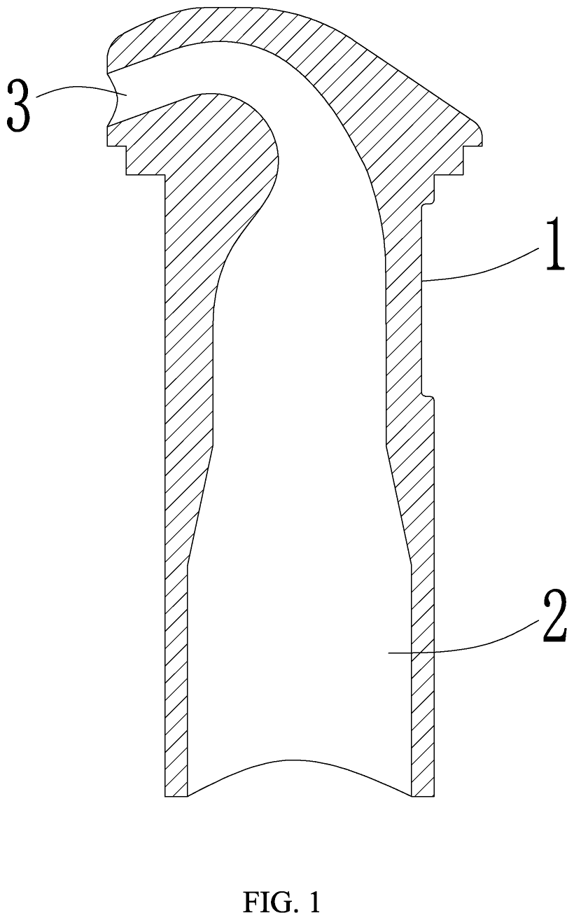

### REFERENCE NUMERALS

1. body; 2. multi-curvature compound-bent internal cavity; 3. connector.

### DETAILED DESCRIPTION OF THE EMBODIMENTS

The present disclosure will be described in further detail with reference to specific embodiments, so that those skilled in the art may understand the present disclosure more clearly.

The following embodiments are only intended to illustrate the present disclosure, but are not intended to limit the scope of the present disclosure. Based on the specific embodiments in the present disclosure, all of the other embodiments obtained by those of ordinary skill in the art without making creative efforts shall fall within the protection scope of the present disclosure.

In the embodiments of the present disclosure, unless otherwise specified, all raw material components are commercially available products well known to those skilled in the art; and in the embodiments of the present disclosure, unless specifically indicated, all technical means used are conventional means well known to those skilled in the art.

Sources of raw materials:
Nitric acid, purchased from Guangzhou Dingbiao Chemical Technology Co., Ltd.; Oxalic acid, purchased from Suzhou Yaxu Fine Chemical Co., Ltd.;
Polyoxymethylene resin, model POM K90-1, purchased from Shanghai Handaer New Materials Co., Ltd.;
Polyketone resin, model Hyosung M230A, purchased from Dongguan Suhe Plastic Co., Ltd.;
316 stainless steel powder and 304 stainless steel powder, both purchased from Hebei Ruihuang Metal Materials Co., Ltd.; and
All other reagents are conventional commercially available products.

### Example 1

This Example provides a preparation process for a metal part with a complex internal cavity, including the following steps:
polymer insert preparation: preparing a polymer insert A strictly matched with an internal cavity of a target metal part in geometric shape from a thermoplastic polymer by using an injection molding process;
mold assembly: precisely fixing the polymer insert A in a predetermined cavity of a metal part forming mold to form a composite cavity structure with a predetermined clearance;
feedstock preparation: mixing 316 stainless steel powder with a particle size of 0.1 μm and binder according to a mass ratio of 55:45 for granulation to prepare feedstock of the metal part, where the thermoplastic polymer and the binder are both polyoxymethylene resin;
injection molding: heating the feedstock of the metal part to a molten state, injecting the feedstock into the predetermined clearance of the composite cavity structure by an MIM device at an injection rate of 50 cm³/s, and cooling to 10° C. at a rate of 20° C./min for dimensional stability to obtain a green part encapsulating the polymer insert A, denoted as a semi-finished product B;
catalytic debinding: placing the semi-finished product B in a catalytic debinding apparatus, introducing a nitrogen protective atmosphere into a closed environment at a temperature of 100° C. and a pressure of 100 MPa, and removing the polymer insert A utilizing 10 vol % gaseous nitric acid; and
sintering molding: transferring the debound semi-finished product B to a sintering apparatus, heating to 1300° C. at a rate of 10° C./min under an argon protective atmosphere, and holding for 2.5 h to cause metal particles to undergo densification sintering to obtain a finished metal part with a complex internal cavity. In this Example, the finished metal part with a complex internal cavity is specifically a metal nozzle including a body 1, a multi-curvature compound-bent internal cavity 2, and a connector 3.

### Example 2

This Example provides a preparation process for a metal part with a complex internal cavity, including the following steps:
polymer insert preparation: preparing a polymer insert A strictly matched with an internal cavity of a target metal part in geometric shape from a thermoplastic polymer by using an injection molding process;
mold assembly: precisely fixing the polymer insert A in a predetermined cavity of a metal part forming mold to form a composite cavity structure with a predetermined clearance;
feedstock preparation: mixing 316 stainless steel powder with a particle size of 0.8 μm and binder according to a mass ratio of 60:40 for granulation to prepare feedstock of the metal part, where the binder and the thermoplastic polymer are both polyoxymethylene resin;
injection molding: heating the feedstock of the metal part to a molten state, injecting the feedstock into the predetermined clearance of the composite cavity structure by an MIM device at an injection rate of 75 cm³/s, and cooling to 20° C. at a rate of 30° C./min for dimensional stability to obtain a green part encapsulating the polymer insert A, denoted as a semi-finished product B;
catalytic debinding: placing the semi-finished product B in a catalytic debinding apparatus, introducing a nitrogen protective atmosphere into a closed environment at a temperature of 120° C. and a pressure of 150 MPa, and removing the polymer insert A utilizing 13 vol % gaseous nitric acid; and
sintering molding: transferring the debound semi-finished product B to a sintering apparatus, heating to 1350° C. at a rate of 15° C./min under an argon protective atmosphere, and holding for 3 h to cause metal particles to undergo densification sintering to obtain a finished metal part with a complex internal cavity. In this Example, the finished metal part with a complex internal cavity is specifically a metal nozzle including a body 1, a multi-curvature compound-bent internal cavity 2, and a connector 3.

### Example 3

This Example provides a preparation process for a metal part with a complex internal cavity, including the following steps:
polymer insert preparation: preparing a polymer insert A strictly matched with an internal cavity of a target metal part in geometric shape from a thermoplastic polymer by using an injection molding process;
mold assembly: precisely fixing the polymer insert A in a predetermined cavity of a metal part forming mold to form a composite cavity structure with a predetermined clearance;
feedstock preparation: mixing 316 stainless steel powder with a particle size of 1.5 μm and binder according to a mass ratio of 65:35 for granulation to prepare feedstock of the metal part, where the binder and the thermoplastic polymer are both polyoxymethylene resin;
injection molding: heating the feedstock of the metal part to a molten state, injecting the feedstock into the predetermined clearance of the composite cavity structure by an MIM device at an injection rate of 100 cm³/s, and cooling to 30° C. at a rate of 40° C./min to obtain a green part encapsulating the polymer insert A after cooling and solidification, denoted as a semi-finished product B;
catalytic debinding: placing the semi-finished product B in a catalytic debinding apparatus, introducing a nitrogen protective atmosphere into a closed environment at a temperature of 140° C. and a pressure of 200 MPa, and removing the polymer insert A utilizing 15 vol % gaseous nitric acid; and
sintering molding: transferring the debound semi-finished product B to a sintering apparatus, heating to 1400° C. at a rate of 20° C./min under an argon protective atmosphere, and holding for 3.5 h to cause metal particles to undergo densification sintering to obtain a finished metal part with a complex internal cavity. In this Example, the finished metal part with a complex internal cavity is specifically a metal nozzle including a body 1, a multi-curvature compound-bent internal cavity 2, and a connector 3.

### Example 4

This Example is different from Example 1 in that the metal powder used is 304 stainless steel powder with a particle size of 0.1 μm; the binder and the thermoplastic polymer are both polyketone resin; the gaseous acidic catalyst used is 10 vol % oxalic acid; and all other components and experimental steps are the same as those in Example 1. In this Example, the finished metal part with a complex internal cavity is specifically a metal nozzle including a body 1, a multi-curvature compound-bent internal cavity 2, and a connector 3.

### Example 5

This Example is different from Example 2 in that the metal powder used is 304 stainless steel powder with a particle size of 0.8 μm; the binder and the thermoplastic polymer are both polyketone resin; the gaseous acidic catalyst used is 13 vol % oxalic acid; and all other components and experimental steps are the same as those in Example 2. In this Example, the finished metal part with a complex internal cavity is specifically a metal nozzle including a body 1, a multi-curvature compound-bent internal cavity 2, and a connector 3.

### Example 6

This Example is different from Example 3 in that the metal powder used is 304 stainless steel powder with a particle size of 1.5 μm; the binder and the thermoplastic polymer are both polyketone resin; the gaseous acidic catalyst used is 15 vol % oxalic acid; and all other components and experimental steps are the same as those in Example 3. In this Example, the finished metal part with a complex internal cavity is specifically a metal nozzle including a body 1, a multi-curvature compound-bent internal cavity 2, and a connector 3.

### Comparative Example 1

This Comparative Example is different from Example 2 in that the binder used is polyoxymethylene resin and the thermoplastic polymer is polyketone resin; and all other components and experimental steps are the same as those in Example 2. In this Comparative Example, the finished metal part with a complex internal cavity is specifically a metal nozzle including a body 1, a multi-curvature compound-bent internal cavity 2, and a connector 3.

### Comparative Example 2

This Comparative Example is different from Example 2 in that the gaseous acidic catalyst used is 20 vol % gaseous nitric acid; and all other components and experimental steps are the same as those in Example 2. In this Comparative Example, the finished metal part with a complex internal cavity is specifically a metal nozzle including a body 1, a multi-curvature compound-bent internal cavity 2, and a connector 3.

### Comparative Example 3

This Comparative Example is different from Example 2 in that the metal powder used is 316 stainless steel powder with a particle size of 2 μm; and all other components and experimental steps are the same as those in Example 2. In this Comparative Example, the finished metal part with a complex internal cavity is specifically a metal nozzle including a body 1, a multi-curvature compound-bent internal cavity 2, and a connector 3. Test Methods:
Linear shrinkage rate: the dimension (L₀) of semi-finished product B and the dimension (L₁) of finished metal nozzle were measured in accordance with MPIF Standard 35-2020 “Material Standards for Metal Injection Molded Parts”, and the linear shrinkage rate was calculated as (L₀−L₁)/L₀×100%;
The debinding rate was determined in accordance with ISO 11358:2012 “Thermogravimetry-Polymer Material Decomposition Processes”;
Residual substance detection: the debinding product was analyzed using Fourier transform infrared spectroscopy, and was determined in accordance with ASTM E1252-14 “Analysis Standard for Organic Residues”;
Relative density of finished product was determined by the Archimedes replacement method in GB/T 208-2021 “Test Method for Density of Aluminum and Aluminum Alloys”;
Tensile strength was tested using a universal testing machine in accordance with GB/T 228.1-2021 “Metallic Materials-Tensile Testing-Part 1: Method of Test at Room Temperature”;
Surface roughness was tested using a roughness profilometer in accordance with ISO 4287:1997 “Surface Texture: Profile Method-Surface Roughness Parameters and their Values”;
Defect detection was performed using scanning electron microscopy (SEM) to observe fracture morphology, and evaluated in accordance with ISO 9444:2017 “Defect Analysis of Metallic Materials”;
Cytotoxicity grade was tested in accordance with GB/T 16886.5-2017 “Biological Evaluation of Medical Devices-Part 5: Tests for In Vitro Cytotoxicity” using the MTT method. L929 cell line was cultured and cell viability was detected. The cytotoxicity grade was determined based on cell viability, and classified into five grades from Grade 0 (non-toxic) to Grade 4 (severely toxic); and
The test results were shown in Table 1.

TABLE 1
Performance test results of finished metal parts

| | | | Proportion of | Relative | | | | |
|---|---|---|---|---|---|---|---|---|
| | Linear | | residual | density of | | | | |
| | shrinkage | Debinding | substance | finished | Tensile | Surface | | Cytotoxicity |
| | rate | rate | peak | product | strength | roughness | Defect | grade |
| Items | (%) | (%) | area (%) | (%) | (MPa) | (Ra) | detection | (Grade) |
| Example 1 | 1.7 | 99.7 | 0.002 | 99.34 | 628 | 1.32 | No | 0 |
| | | | | | | | cracks | |
| Example 2 | 1.5 | 99.8 | 0.001 | 99.65 | 645 | 1.28 | No | 0 |
| | | | | | | | cracks | |
| Example 3 | 1.8 | 99.6 | 0.004 | 99.42 | 634 | 1.41 | No | 0 |
| | | | | | | | cracks | |
| Example 4 | 2.1 | 98.7 | 0.016 | 99.18 | 615 | 1.58 | No | 0 |
| | | | | | | | cracks | |
| Example 5 | 1.9 | 98.4 | 0.011 | 99.23 | 624 | 1.47 | No | 0 |
| | | | | | | | cracks | |
| Example 6 | 2.5 | 97.8 | 0.013 | 99.29 | 607 | 1.53 | No | 0 |
| | | | | | | | cracks | |
| Comparative | 4.7 | 92.3 | 0.034 | 76.8 | 323 | 1.82 | Cracks | 0 |
| Example 1 | | | | | | | | |
| Comparative | 3.2 | 99.2 | 0.036 | 80.1 | 356 | 1.94 | Cracks | 0 |
| Example 2 | | | | | | | | |
| Comparative | 5.2 | 98.7 | 0.052 | 82.6 | 387 | 1.98 | Cracks | 0 |
| Example 3 | | | | | | | | |

Based on the above experimental data, the linear shrinkage rate of the semi-finished product B in Examples 1-6 was 1.5-2.5%, the debinding rate reached over 99.5%, there was very little residue, the relative density of the finished product was over 99%, the tensile strength of the finished metal parts reached over 600 MPa, the surface roughness Ra≤1.6 μm, no cracks were found in defect detection, and the biocompatibility was good with no cytotoxicity. Further analysis also revealed that the experimental data of Examples 1-3 were superior to those of Examples 4-6. This may be because Examples 1-3 used polyoxymethylene resin as both a binder and a thermoplastic polymer, combined with 316 stainless steel powder, and combined with nitric acid to achieve synergistic effect. Specifically, under acid catalysis, the carbon-oxygen bonds of the polyoxymethylene resin broke to generate gaseous formaldehyde molecules, which were easily volatilized and discharged, resulting in more thorough debinding. The 316 stainless steel powder used contained molybdenum, which significantly enhanced its corrosion resistance in acidic environments, making it suitable for use with nitric acid catalysts, and during catalytic debinding, it could still maintain surface integrity when facing nitric acid vapor and reduced oxidation or corrosion defects. Nitric acid was used as a gaseous acidic catalyst. Nitric acid vapor had strong permeability and a fast reaction rate, which could rapidly induce the decomposition of polyoxymethylene resin. However, Examples 4-6 used polyketone resin as both a binder and a thermoplastic polymer. Under acid catalysis, the polyketone resin generated oligomers, CO/CO₂ and other mixed products. Some oligomers might remain inside the green part, affecting the relative density and microstructure uniformity. Oligomer residues might lead to local stress concentration in the finished product, and reduced the mechanical strength of the finished product. Examples 4-6 used 304 stainless steel powder, which did not contain molybdenum and was more sensitive to acidic environments, easily causing surface oxidation or micro-corrosion and affecting the final surface roughness. Examples 4-6 used oxalic acid as a gaseous acidic catalyst. Oxalic acid was large in molecules, had a slow permeation rate, and had relatively low catalytic efficiency on polyketone resin, which could easily cause uneven debinding, resulting in large residual stress inside the green part and affecting the shrinkage uniformity in the subsequent sintering process. It could be seen that the entire system of Examples 1-3 had better synergy and was more likely to obtain high-density and high-quality metal parts. Further analysis of the above experimental data also revealed that in Comparative Example 1, when the material used for the polymer insert A was inconsistent with the binder, the debinding rate decreased, residues increased, and the mechanical properties and relative density of the finished metal parts became poor. This might be due to the poor compatibility between the metal feedstock and the polymer insert, the occurrence of interfacial delamination, and the mismatch in decomposition temperatures between the two led to a prolonged debinding cycle, incomplete binder decomposition, and increased residues, ultimately resulting in poor mechanical properties and increased surface roughness of the finished metal parts. Excessively high concentration of the gaseous acidic catalyst used in Comparative Example 2 caused cracks in the finished metal parts. This might be because excessively high concentration of the gaseous acidic catalyst made the chemical reaction faster and more intense, leading to a sharp rise in local temperature and the generation of thermal stress. Due to inconsistent reaction rates in different areas, residual stress easily formed inside the metal parts, leading to the formation of microcracks. In Comparative Example 3, the use of stainless steel powder with larger particle size also resulted in poor mechanical properties and cracks in the finished metal parts. This might be because the stainless steel powder with larger particle size exhibited reduced flowability and uneven local density during injection molding, making it more prone to rapid growth of local grains during sintering, resulting in a non-uniform structure.

In summary, the present discloses provides a preparation process for a metal part with a complex internal cavity. A decomposable polymer insert A strictly matched with an internal cavity of a target metal part in geometric shape is pre-manufactured by injection molding to serve as a placeholder structure, then the polymer insert A is precisely fixed in a predetermined cavity of a forming mold during mold assembly to form a composite cavity structure with a predetermined clearance; metal nozzle feedstock is injected into the predetermined clearance of this composite cavity structure during injection molding, and the polymer insert A and binder are removed utilizing a gaseous acidic catalyst, thereby obtaining a high-precision metal part with a complex internal cavity, solving the technical problems of inability to machine complex internal cavities of the conventional CNC, high roughness of 3D-printed internal surfaces, and demolding difficulties in the MIM injection molding process. This process combines MIM metal injection molding with insert molding technology, circumvents the reliance on high-end CNC devices or imported 3D printing devicest traditionally required for metal parts with complex internal cavities, reduces the demand threshold for specialized cutting tools and forming devices, and provides a feasible pathway for domestic enterprises to achieve independent and controllable production of precise metal nozzles, contributing to breaking the long-term monopoly of Japanese enterprises in this field and enhancing the security of the medical device industry chain.

The above are only embodiments of the present disclosure and are not intended to limit the present disclosure. Various modifications and variations can be made to the present disclosure by those skilled in the art. Any modifications, equivalent substitutions, improvements, etc., made within the spirit and principle of the present disclosure should be included within the scope of the claims of the present disclosure.

What is claimed is:

1. A preparation process for a metal part with a complex internal cavity, comprising the following steps:
polymer insert preparation: preparing a polymer insert A strictly matched with an internal cavity of a target metal part in geometric shape from a thermoplastic polymer by using an injection molding process;
mold assembly: precisely fixing the polymer insert A in a predetermined cavity of a metal part forming mold to form a composite cavity structure with a predetermined clearance;
feedstock preparation: mixing metal powder and binder according to a mass ratio of 55-65:45-35 for granulation to prepare feedstock of the metal part, the binder and the thermoplastic polymer being the same compound;
injection molding: heating the feedstock of the metal part to a molten state, injecting the feedstock into the predetermined clearance of the composite cavity structure by an MIM device, and performing cooling for dimensional stability to obtain a green part encapsulating the polymer insert A, denoted as a semi-finished product B;
catalytic debinding: placing the semi-finished product B in a catalytic debinding apparatus, introducing a first inert gas protective atmosphere into a closed environment at a temperature of 100-140° C. and a pressure of 100-200 MPa, and removing the polymer insert A and the binder utilizing a gaseous acidic catalyst; and
sintering molding: transferring the debound semi-finished product B to a sintering apparatus, heating to 1300-1400° C. at a rate of 10-20° C./min under a second inert gas protective atmosphere, and holding for 2.5-3.5 h to cause metal particles to undergo densification sintering to obtain a finished metal part with a complex internal cavity.

2. The preparation process for a metal part with a complex internal cavity according to claim 1, wherein the thermoplastic polymer and the binder are both polyoxymethylene resin.

3. The preparation process for a metal part with a complex internal cavity according to claim 1, wherein the thermoplastic polymer and the binder are both polyketone resin.

4. The preparation process for a metal part with a complex internal cavity according to claim 2, wherein the catalyst is nitric acid or oxalic acid.

5. The preparation process for a metal part with a complex internal cavity according to claim 1, wherein a vapor concentration of the catalyst is controlled within the range of 10 vol % to 15 vol %.

6. The preparation process for a metal part with a complex internal cavity according to claim 1, wherein the metal powder used for preparing the feedstock of the metal part is stainless steel powder.

7. The preparation process for a metal part with a complex internal cavity according to claim 6, wherein the stainless steel powder has a particle size of 0.1-1.5 μm.

8. The preparation process for a metal part with a complex internal cavity according to claim 1, wherein the first inert gas protective atmosphere is nitrogen, and the second inert gas protective atmosphere is argon.

9. The preparation process for a metal part with a complex internal cavity according to claim 1, wherein during the injection molding, an injection rate is controlled within the range of 50 cm³/s to 100 cm³/s, and cooling is performed at a rate of 20-40° C./min for dimensional stabilization.

10. A metal nozzle, manufactured by using the preparation process for a metal part with a complex internal cavity according to claim 1, comprising a body, a multi-curvature compound-bent internal cavity, and a connector.
